(19) United States
(12) Patent Application Publication
(10) Pub. No.: US 2013/0054479 A1
(43) Pub. Date: Feb. 28, 2013

(54) DETERMINING LIKELIHOOD OF CUSTOMER ATTRITION OR RETENTION

(71) Applicants: Erik Stephen Ross, Charlotte, NC (US); Katherine Ann Krumme, San Francisco, CA (US)

(72) Inventors: Erik Stephen Ross, Charlotte, NC (US); Katherine Ann Krumme, San Francisco, CA (US)

(73) Assignee: Bank of America Corporation, Charlotte, NC (US)

(21) Appl. No.: 13/218,062

(22) Filed: Aug. 25, 2011

(51) Int. Cl. G06Q 10/00

(52) U.S. Cl. 705/319; 705/1.1

(57) ABSTRACT

A method identifies one or more customers likely of attriting. The method includes collecting a first set of customer data from one or more social networks in which the customer is a member, where the first set of customer data is indicative of a degree of connection of each of a plurality of connections within the one or more social networks. The method then collects a second set of customer data, where the second set of customer data comprises data available to an entity based on prior interactions between the entity and the customer. Next, the second set of customer data is analyzed to identify any negative interactions between the entity and the customer. Finally, information regarding the identified negative interactions is correlated with the first set of customer data to identify one or more connections as customers of the entity at risk of attriting.

### FIELD

In general, embodiments of the invention relate to determining likelihood of customer attrition or retention.

### BACKGROUND

Recent years have seen a vast expansion of the use of social networks to connect individuals, access information and communicate with groups of people that share similar backgrounds, interests or characteristics. The rise of social networks presents an opportunity for businesses to both identify information about their customers and potential customers as well as information about the people or entities with which the customer/potential customer associates, in order to help assess the customer's likelihood of attrition and/or retention.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention, a method identifies one or more customers likely of attriting and includes collecting a first set of customer data from one or more social networks in which the customer is a member, where the first set of customer data is indicative of a degree of connection of each of a plurality of connections within the one or more social networks. The method also includes collecting a second set of customer data, where the second set of customer data comprises data available to an entity based on prior interactions between the entity and the customer. The method further includes analyzing, using a processing device, the second set of customer data to identify any negative interactions between the entity and the customer and correlating, using a processing device, information regarding the identified negative interactions with the first set of customer data to identify one or more connections as customers of the entity at risk or attriting.

In some embodiments, the first set of customer data comprises a network position of the customer. In some embodiments, the second set of customer data comprises transactional data collected by the entity based on one or more financial transactions conducted with the customer. In some embodiments, the second set of customer data comprises account history data. In some embodiments, the second set of customer data comprises biographical data corresponding to one or more connections of the customer. In some embodiments, analyzing the first set of customer data includes creating, using the processing device, a hierarchy of influence, wherein the levels of connections between two or more of the connections in the customer's social network are compared and assigning, using the processing device, a relative connection value based on the comparison.

In some embodiments, analyzing the second set of customer data includes determining the interval of time between interactions within the second set of customer data and the present and assigning, using the processing device, a relative interaction value based on the determined interval. In some such embodiments, analyzing the first set of customer data includes creating, using the processing device, a hierarchy of influence, wherein the levels of connections between two or more of the connections in the customer's social network are compared and assigning, using the processing device, a relative connection value based on the comparison. In some such embodiments, correlating information regarding the identified negative interaction with the first set of customer data comprises combining the relative connection value and the relative interaction value. In some such embodiments, combining the relative interaction value and the relative connection value comprises summing the relative interaction value and the relative connection value. In other such embodiments, combining the relative interaction value and the relative connection value comprises multiplying the relative interaction value by the relative connection value.

In some embodiments, the method also includes collecting a third set of customer data wherein the third set of customer data comprises data available to an entity based on prior interactions between the entity and one or more of the plurality of connections within the one or more social networks. In some such embodiments, the method also includes assigning, using the processing device, a relative interaction value to each of the plurality of connections based on an analysis of the third set of customer data and determining, using the processing device, a weighted connection value comprising combining the relative interaction value and the relative connection value of each of the plurality of connections. In some such embodiments, the method also includes creating, using the processing device, a hierarchy of attrition risk, where the weighted connection values between two or more of the connections in the customer's social networks are compared and those connections deemed more likely to attrite are assigned a relatively high probability of attrition and those connections deemed less likely to attrite are assigned a relatively low probability of attrition. In some such embodiments, the method also includes initiating communication with one or more of the connections in the customer's social network based on the hierarchy of influence. In some such embodiments, the initiated communication is one or more of an email, text message, automatic offer, or customer service telephone call.

According to embodiments of the invention, a system identifies one or more customers likely of attriting. The system includes a processing device configured for collecting a first set of customer data from one or more social networks in which the customer is a member, wherein the first set of customer data is indicative of a degree of connection of each of a plurality of connections within the one or more social networks, collecting a second set of customer data, wherein the second set of customer data comprises data available to an entity based on prior interactions between the entity and the customer, analyzing the second set of customer data to identify any negative interactions between the entity and the customer and correlating information regarding the identified negative interactions with the first set of customer data to identify one or more connections as customers of the entity at risk or attriting.

In some embodiments, the first set of customer data comprises a network position of the customer. In some embodiments, the second set of customer data comprises transactional data collected by the entity based on one or more financial transactions conducted with the customer. In some embodiments, the second set of customer data comprises account history data. In some embodiments, the second set of customer data comprises biographical data corresponding to one or more connections of the customer. In some embodiments, analyzing the first set of customer data includes creating a hierarchy of influence, where the levels of connections between two or more of the connections in the customer's social network are compared and assigning a relative connection value based on the comparison.

In some embodiments, analyzing the second set of customer data includes determining the interval of time between interactions within the second set of customer data and the present and assigning a relative interaction value based on the determined interval. In some such embodiments, analyzing the first set of customer data includes creating a hierarchy of influence, wherein the levels of connections between two or more of the connections in the customer's social network are compared and assigning a relative connection value based on the comparison. In some such embodiments, correlating information regarding the identified negative interaction with the first set of customer data includes combining the relative connection value and the relative interaction value. In some such embodiments, combining the relative interaction value and the relative connection value comprises summing the relative interaction value and the relative connection value. In other such embodiments, combining the relative interaction value and the relative connection value comprises multiplying the relative interaction value by the relative connection value.

In some embodiments, the processing device is further configured for collecting a third set of customer data wherein the third set of customer data comprises data available to an entity based on prior interactions between the entity and one or more of the plurality of connections within the one or more social networks. In some such embodiments, the processing device is further configured for assigning a relative interaction value to each of the plurality of connections based on an analysis of the third set of customer data and determining a weighted connection value comprising combining the relative interaction value and the relative connection value of each of the plurality of connections. In some such embodiments, the processing device is further configured for creating a hierarchy of attrition risk, wherein the weighted connection values between two or more of the connections in the customer's social networks are compared and those connections deemed more likely to attrite are assigned a relatively high probability of attrition and those connections deemed less likely to attrite are assigned a relatively low probability of attrition. In some such embodiments, the processing device is further configured for initiating communication with one or more of the connections in the customer's social network based on the hierarchy of influence. In some such embodiments, the initiated communication is one or more of an email, text message, automatic offer, or customer service telephone call.

According to embodiment of the invention, a computer program product includes a non-transient computer readable memory having computer executable computer instructions for identifying one or more customers likely of attriting. The instructions include instructions for collecting a first set of customer data from one or more social networks in which the customer is a member, where the first set of customer data is indicative of a degree of connection of each of a plurality of connections within the one or more social networks, instructions for collecting a second set of customer data, wherein the second set of customer data comprises data available to an entity based on prior interactions between the entity and the customer, instructions for analyzing the second set of customer data to identify any negative interactions between the entity and the customer and instructions for correlating information regarding the identified negative interactions with the first set of customer data to identify one or more connections as customers of the entity at risk or attriting.

In some embodiments, the first set of customer data comprises a network position of the customer. In some embodiments, the second set of customer data comprises transactional data collected by the entity based on one or more financial transactions conducted with the customer. In some embodiments, the second set of customer data comprises account history data. In some embodiments, the second set of customer data comprises biographical data corresponding to one or more connections of the customer. In some embodiments, the instructions for analyzing the first set of customer data include instructions for creating a hierarchy of influence, wherein the levels of connections between two or more of the connections in the customer's social network are compared and instructions for assigning a relative connection value based on the comparison.

In some embodiments, the instructions for analyzing the second set of customer data comprise instructions for determining the interval of time between interactions within the second set of customer data and the present and instructions for assigning a relative interaction value based on the determined interval. In some such embodiments, the instructions for analyzing the first set of customer data comprise instructions for creating a hierarchy of influence, wherein the levels of connections between two or more of the connections in the customer's social network are compared and instructions for assigning a relative connection value based on the comparison. In some such embodiments, the instructions for correlating information regarding the identified negative interaction with the first set of customer data comprise instructions for combining the relative connection value and the relative interaction value. In some such embodiments, the instructions for combining the relative interaction value and the relative connection value comprise instructions for summing the relative interaction value and the relative connection value. In other such embodiments, the instructions for combining the relative interaction value and the relative connection value comprise instructions for multiplying the relative interaction value by the relative connection value.

In some embodiments, the instructions further comprise instructions for collecting a third set of customer data wherein the third set of customer data comprises data available to an entity based on prior interactions between the entity and one or more of the plurality of connections within the one or more social networks. In some such embodiments, the instructions also include instructions for assigning a relative interaction value to each of the plurality of connections based on an analysis of the third set of customer data and instructions for determining a weighted connection value comprising combining the relative interaction value and the relative connection value of each of the plurality of connections. In some such embodiments, the instructions further comprise instructions for creating a hierarchy of attrition risk, wherein the weighted connection values between two or more of the connections in the customer's social networks are compared and those connections deemed more likely to attrite are assigned a relatively high probability of attrition and those connections deemed less likely to attrite are assigned a relatively low probability of attrition. In some such embodiments, the instructions further comprise instructions for initiating communication with one or more of the connections in the customer's social network based on the hierarchy of influence. In some such embodiments, the initiated communication is one or more of an email, text message, automatic offer, or customer service telephone call.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for determining likelihood of customer attrition or retention, in accordance with embodiments of the invention.

FIG. 2 is a flow diagram illustrating a process flow for collecting sets of data relating to the customer's social network and interactions, in accordance with embodiments of the invention.

FIG. 3 is a mixed block and flow diagram illustrating an apparatus for analyzing collected customer data, in accordance with embodiments of the invention.

FIG. 4 is a. block diagram illustrating an apparatus, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the present invention described herein are generally described as involving a merchant or business, it will be understood that this may involve one or more persons, organizations, businesses, institutions and/or other entities such as financial institutions, services providers etc. that implement one or more portions of one or more of the embodiments described and/or contemplated herein.

The term “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks such as Facebook®, Twitter®, Linkedin®, YouTube® as well as any one or more existing web logs or “blogs, ” forums and other social spaces.

The terms “connection” or “connections”, as used herein in the context of a social network, refer to one or more members of an individuals' social network. For example, a person's family members or friends may be considered individually as a connection within the person's social network, or collectively as the person's connections.

Embodiments of the invention provide for identifying customers at risk of attriting. The determination is based on a correlation of information regarding identified negative interactions with social network data related to a customer. The social network data is collected and is indicative of a number and a degree of each of a plurality of connections of the customer. Customer data regarding the customer's prior interactions with an entity such as a financial institution is also collected. The customer data is analyzed to identify any negative interactions between the customer and the entity such as adverse and/or failed customer interactions. In some embodiments, the customer data considered may also include data regarding the customer's personal actions, including but not limited to, prior default, bankruptcy, breach of term contract, high revolving debt, sudden changes in credit behavior etc., and the interaction histories of those people and organizations with whom the customer associates, that is, those people or entities in the customer's social network. Embodiments of the present invention leverage the fact that social networks are a grouping of individuals or organizations based on commonalities between the individual and his or her connections. Accordingly, individuals in similar economic and life circumstances, with similar network values may be connected within a social network. Thus, information about a customer's connections may suggest information about the customer. Moreover, connections within a social network may be in a position to influence a customer's decision making processes and so trends within an individual's social network may trickle down to the customer and vice versa—the customer's behavior may trickle down to the customer's connections. More specifically, the connections closest to the customer, i.e. first and possibly second tier or degree connections, may be greatly effected by the customer's actions, whereas connections farther removed from the customer are much less likely to be effected by the customer's actions. For instance, and without limitation, if a customer has experienced a negative outcome with regard to services provided by an entity, such as a financial institution, then the customer may be likely to remove the customer's business from the entity or “attrite” from the entity. Furthermore, the customer's social network, particularly the customer's close social network, such as first and possibly second degree connections may be likely to receive communications from the customer regarding the customer's negative outcome or interaction and therefore likewise attrite and/or postpone or cancel future interactions with the entity.

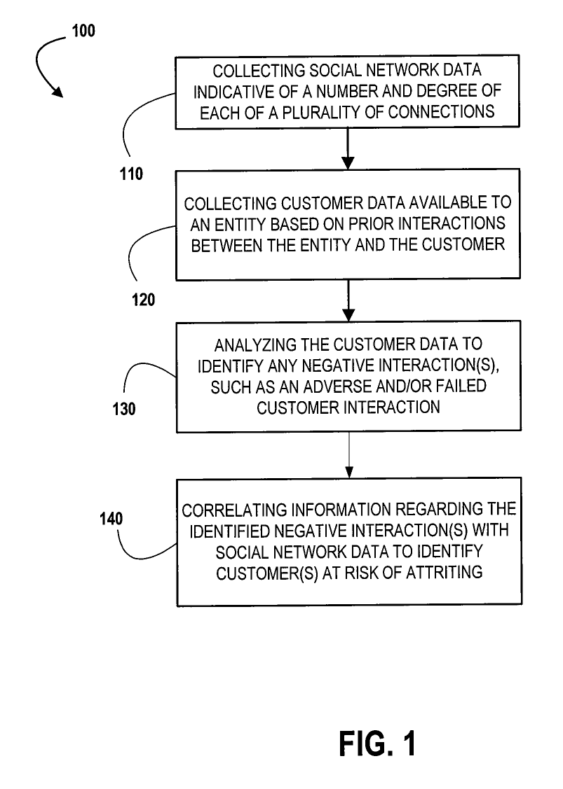

FIG. 1 illustrates a general process flow 100 for determining customers at risk of attriting, in accordance with embodiments of the invention. As represented by block 110 a first set of data is collected, for example using a processing device. The first set of data may be or include social network data indicative of a number and degree or level of each of a plurality of connections of the customer. As represented by block 120, a second set of customer data is also collected, such as by a processing device, where the second set of customer data is customer data available to an entity such as a financial institution, merchant, retailer, service provider or the like, based on prior interactions with the customer. Both sets of data are analyzed, as represented by block 130, to identify any negative interactions between the customer and the entity. A negative interaction is any interaction between the customer and the entity where the customer may have or has confirmed that the customer has a negative feeling regarding the outcome of the interaction. For example, in some instances, the customer may provide insight into the customer's feelings toward an interaction by posting on a social network or otherwise. Embodiments of the invention collect data regarding the customer's assertions regarding the customer's feelings regarding an interaction. In another example, the customer is asked for feedback regarding an interaction, and the customer provides feedback indicating the customer's negative feelings regarding a transaction to the entity directly.

As represented by block 140 customer at risk of attriting, or conversely, customers likely to be retained, are identified by correlating information regarding the identified negative interactions with social network data. For example, in some embodiments, a serious negative interaction is identified corresponding to the customer. The customer has a finite set of first degree connections, and customer's risk of attriting is determined to be high based on the high level of seriousness of the negative interaction. The connections' risks of attriting are also determined to be high based on the seriousness of the negative interaction and those connections' first degree of connection with the customer.

Thus, in various embodiments, a level of seriousness regarding the negative interaction is determined based on predetermined metrics and/or the determined actual level of seriousness based on assertions made directly by the customer. In some embodiments, additional information regarding each of the connections is collected and analyzed to further assist in determining a risk of the particular connections attriting. The connections of the customer may include both customer-connections, which are those connections that have a preexisting relationship with the entity and non-customer connections, which are those connections that do not have a preexisting relationship with the entity. In one example, the long length of the connection-customer's relationship with the entity may indicate the connection-customer is unlikely to attrite, especially considering the customer's negative interaction was considered minor. In another example, the breadth of the connection-customer's relationship with the entity may indicate the connection-customer is unlikely to attrite if the relationship spans several products provided by the entity. In various other embodiments, other information regarding each of the connections individually may be taken into consideration in determining the specific customer-connection's likelihood of attriting. In other examples, a non-customer connection's likelihood of establishing a relationship with the entity is evaluated. In this regard, the non-customer connection may be a potential customer who is connected with the customer who experienced a negative interaction.

In various embodiments, the entity may choose to provide communications such as targeted marketing materials directly addressing the specific negative interaction. In other embodiments, the entity may choose to send communications to the customer him or herself in an effort to resolve the negative interaction and salvage the relationship. Some examples of the communications that may be send by the entity to the customer, the customer-connection and/or the non-customer connection are emails, text messages, automatic offers, automatic enrollments, telephone call from customer service and the like.

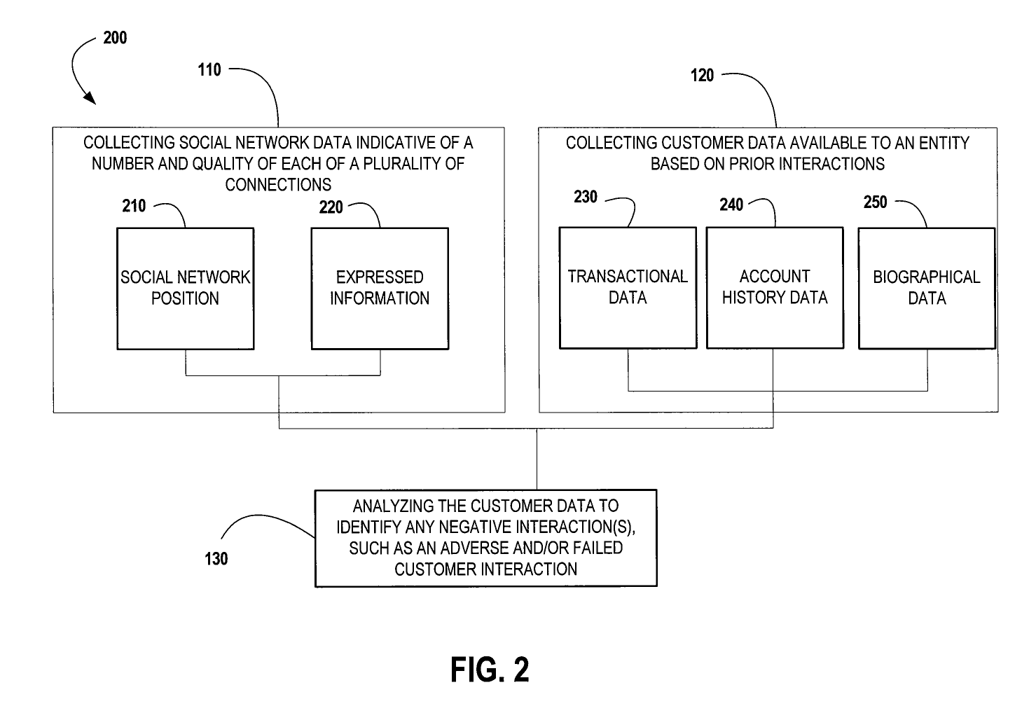

Embodiments of the process flow 100, and systems for performing the process flow 100, are described in greater detail below with reference to FIGS. 2-4.

FIG. 2 provides a flow diagram 200 illustrating a general process flow of an apparatus or system for collecting sets of data from a customer's social network, such as a customer's social network data 110 and customer data available to an entity based on prior transactions 120. The process flow, represented by block 110, of collecting social network data indicative of a number and quality of each of a plurality of connections may include collecting information regarding the customer's social network position, represented by block 210, and collecting expressed information from the customer's social network, block 220. The customer's social network position includes any information relating to the identity of the customer's connections, the nature and degree of connection between the customer and his or her connections and, in some embodiments, other information about the customer and/or the customer's connections such as information regarding whether the customer's connections are customer-connections or non-customer connections. For instance, a customer's social network data may indicate that the individual has a number of connections with whom he regularly interacts (i.e. electronic communications, postings, comments etc.) and some connections with whom he interacts little. Information regarding the customer's connections may be available from publicly available profiles, information uploaded to the social network, comments made to the customer etc. All of this information defines the customer's social network position and provides information regarding the likelihood of the connections' attrition or retention in the event of a negative interaction between the customer and the entity. By way of example, if a customer's best friend is a customer and the customer has a moderate negative interaction with the entity, the customer's best friend may be more likely to attrite from the entity than a remote acquaintance of the customer.

As noted, collecting social network data that is indicative of a number and quality of each of a plurality of connections may also include collecting expressed information, as represented by block 220. Expressed information includes any information or data that is disclosed by the customer or her connections within the social network. Expressed information includes, but is not limited to, postings, comments, profile information, blog entries, micro-blog entries, updates, communications, photos, chat entries etc. Such information may relate to the customer's personal actions or may include information regarding the customer's connections' actions. By way of example, if a customer creates a blog entry describing his interactions with the entity and expressing his doubts that he will ever purchase another product from the entity based on a negative outcome during a prior transaction, such information will directly relate to the customer's likelihood of attrition and the customer's connections' individual likelihoods of attriting. Similarly, if a close friend of the customer posts a comment on the wall of the customer's Facebook® account indicating the friend is sorry to hear that the friend was displeased with the interest rate offered by the entity during the customer's recent mortgage application, this may also be indicative that the customer may represent an increased risk of attriting and that the customer's connections', particularly the close friend, may be in danger of attriting. Another example of expressed information may include a close friend or family member's tweets from a Twitter® account that the customer follows where the connection boasts of receiving a higher rate of return in his investment account than the customer receives in her investment account maintained by the entity.

Additionally, a customer may provide the merchant access to the customer's e-mail or other electronic communications, or some portion thereof (e.g. recipient's name, contents of the “re” line etc.) to identify those individuals or organizations with which the customer regularly corresponds or interacts.

The second set of data being collected by the system or apparatus, as illustrated by block 120, may include the customer's transactional data, represented by block 230. Transactional data includes, but is not limited to, data regarding the date, location, amount, method of payment and the like of the transactions of the customer and/or the customer's connections. In some embodiments, the data collected also includes data regarding broad financial picture of the customer and/or the customer's connections. Transactional data can be information relating to a present transaction (i.e. the purchase of a car) or can be historical data relating to previous purchases. The second set of customer data may also include the customer's account history data, as illustrated by block 240. Account history data includes, without limitation, such data as the types of accounts the customer has (e.g. credit, checking, savings, investment, lay-away, financing etc.) and the current and historical balances of such accounts, account activity etc. For example, data regarding the amount of deposits with a financial institution or several financial institutions may be collected. As another example, data regarding rates of return of investments as well as comparisons to standards for return or indexes may be collected in order to indicate potential dissatisfaction by a customer with regard to rates of returns of investments. In some embodiments, numbers indicative of the customer's net worth or other evaluation information may be collected. Similar information regarding the customer's network connections may be collected in various embodiments. In some embodiments, as mentioned above, transaction data is collected. As exemplified by block 250, the second set of customer data may also include biographical data of the customer. Biographical data includes, but is not limited to, the age, sex, marital status, place of residence, current location, number of children, employment status etc. of a customer.

The customer data is information that is available to an entity such as a merchant based on prior interactions with the customer. For instance, a financial institution may have access to transactional, account history and biographical data of its customers by virtue of the accounts and financial services that customer utilizes through the financial institution. Retailers may have access to similar information through past purchases made by the customer through the retailer's stores. Other merchants may have direct access to similar information or it may be available to them through relationships the merchant has with other entities, such as financial institutions, marketing companies etc.

In some embodiments, in addition to transactional data, the second set of customer data may include data related to call center transcript data and/or any interaction or other communication, such as a text message, online chat or anything in the public domain.

The first set of data, related to the customer's social network, may be collected in a number of different ways. Some social networking data can inferred from other customer data (i.e. the second set of customer data). For instance, the transactional data available to the merchant may illustrate the businesses connections within the customer's social network based on frequent transactions with the business. Similarly the transactional data and/or the account history data may demonstrate recurring deposits from a company representing an employer connection. Biographical data may identify the customer's family connections. Collecting social network data may also involve the business, merchant, financial institution etc. associating itself with the customer on an already-existing social network, such as Facebook®, wherein the business may receive access to additional information regarding the customer's social network data. Furthermore, a merchant may independently create a unique social network and invite the customer to join the network and to bring his or her connections and thereby have access to the customer's social network data by virtue of hosting the social network. As illustrated by the remainder of the process flow 200, the first and second sets of customer data are analyzed to combine the data and identify any negative interactions such as an adverse and/or failed customer interaction 130.

The first and second sets of data may be correlated to indicate a likelihood of a customer attriting and/or the customer's connections attriting. The first set of data, related to social network data may be analyzed and used to determine a relative connection value for each individual connection. The relative connection value may be based on a determination of the degree of connection of the customer and the connection. For example, a connection that is a first degree connection may be assigned a relative connection value of 100 out of 100, whereas a second degree connection may be assigned a relative connection value of 70 out of 100, a third degree connection may be assigned a relative connection value of 10 out of 100, and a remote connection or non-connection may be assigned a relative connection value of 0 out of 100. The relative connection value may also be based, in part, on the activeness of the connection within one or more social networks. This may be taken into account because a connection that is very inactive on a social network may not be likely to be influenced by information posted on a social network. The second set of data, related to interactions between the customer and the entity and/or between the customer's connections and the entity may be analyzed and used to determine a relative interaction value. For example, if the customer has a negative interaction with the entity and the customer provides feedback to the entity or posts a social network post indicating the customer's serious displeasure with the outcome of the interaction, the relative interaction value may be assigned a 100 out of 100, whereas, if the customer indicates an extremely positive outcome from a transaction, the relative interaction value may be assigned as a 0 out of 100. The relative connection value and the relative interaction value may be combined in order to determine the likelihood of the connection attriting or being retained.

Take for example a financial institution that has access to biographical information 250 of its customer indicating that the customer is a twenty year old male. The customer's account history data 240 indicates the customer has had a checking account with the financial institution for a number of years and for the past two years there has been a recurring bi-weekly deposit being made from the same company to the customer's account (suggesting a steady income). However, within the past two months the recurring deposit has stopped and the customer's rate of interest has declined due to declining recurring balances in the account. The account history data 240 indicates that the customer has missed consecutive payments on his credit accounts. This data alone may indicate to the financial institution that the customer is likely to attrite based on a potential displeasure with his interest rate declining in circumstances that seem to indicate the customer has lost his job. Therefore, the customer may be considered to have a high likelihood of attriting. If the customer has a social network, and particularly if the customer has expressed explicit displeasure with the entity, then the customer's connections, especially close connections may also be considered likely to attrite. On the other hand, in some situations, depending on the stance of the institution any expressed information collected with regard to the customer, the customer may be considered to be less likely to attrite, regardless of the decrease in rate of return, based on the number of products being used by the individual and the individual's long-standing business with the entity. In such instances, the institution may consider the number of products being used by the individual as a positive that the individual may pass along positive comments via social network to the customer's connections.

In other instances the first and second set of data must be combined to correlate to indicators of attrition and/or retention. For example, a financial institution, by virtue of its relationship with its customer, may have access to data regarding the customer's income, mortgage payment and savings. This data considered alone may indicate a customer's likelihood of attriting, but does not necessarily indicate the likelihood of the customer's connections' likelihood of attriting. In fact, data collected regarding the customer's accounts and/or financial obligations and the like, as well as data collected regarding the customer's social network connections' accounts and/or financial obligations and the like may paint a more comprehensive picture of the customer's connections' likelihoods of attriting. As an example, the first set of data indicates that a number of the customer's neighbors, many of whom are within the customer's social network, have stopped making their mortgage payments despite appearing to be in a financial position to continue to make those payments (e.g. neighbor's updates discuss the default but social network page also includes photos from international vacation and shopping trip). Moreover, according to the customer's Twitter® feed the customer recently received a tweet from one of his neighbors including a link to an article discussing the practice of strategic default. This data, when combined with information taken from the biographical information 250 available to the financial institution, indicates the customer lives in a neighborhood where the housing values have depreciated significantly. Therefore, depending on the institution's stance toward the situation may effect the customer's likelihood of attriting. Should the customer follow through with a default, the customer may be very unlikely to continue a relationship with the institution. Of course, if such data is collected, the entity may choose to preemptively contact the customer to discuss the customer's options before defaulting as well. Such actions may assist in building a stronger relationship with the customer and may also result in retaining the customer, regardless of the mortgage default.

As another example, a customer may be travelling and the customer's credit card may be placed on hold by the entity. In some situations, this may be due to a security feature where foreign purchases are flagged as probable stolen cards or otherwise. A customer may face extremely difficult circumstances if the customer is left without a method of payment in a foreign country. In this example, if the customer's connections have also experienced a similar incident or some other negative incident, then such connections may be at a hightened risk for attriting as opposed to those connections that are only influenced by communications regarding the customer's troubles.

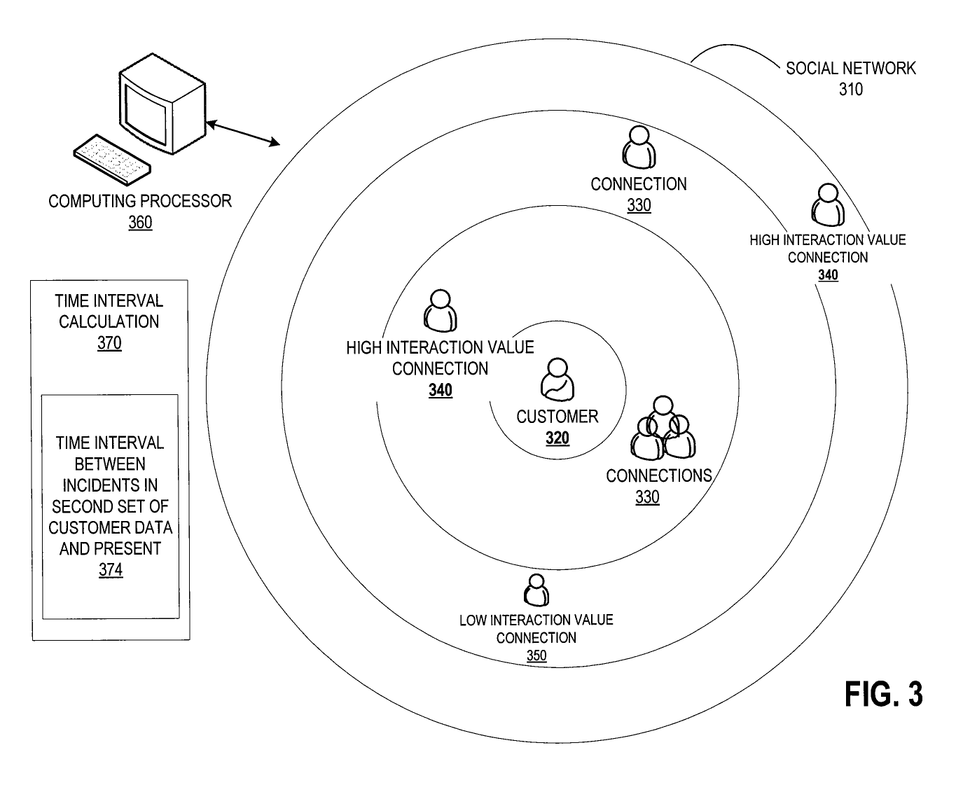

Referring now to FIGS. 1 and 3, after the first and second sets of data are collected 110 and 120, the data is analyzed to combine the data and/or correlate the data to indicators of negative interactions 130. FIG. 3 illustrates a mixed block and flow diagram illustrating an apparatus for analyzing collected customer data, in accordance with embodiments of the invention, comprising a social network 310, a customer 320 and the customer's connections 330, some of which are high interaction value connections 340 and some of which are low interaction value connections 350. A high interaction value connection 340 is a connection that is deemed to be a connection having a high likelihood of attriting (or being retained) based on data collected regarding the connection's personal financial and/or interaction history and expressed information. In some embodiments, the timing of the connection's last interaction with the financial institution dictates the connection's interaction value. In other embodiments, more complex algorithms are used to determine the connection's interaction value, such as an aggregate analysis of the connection's interaction with the institution over the last six months or a year or the like. In some embodiments, the level of interactions, and/or the level of balances or worth of the connection's products held by the institution are taken in consideration. For example, if the connection regularly makes transactions over a predetermined level and holds a total available balance over a predetermined threshold, but recently had a relatively minor negative interaction whereby the customer was charged a maintenance fee on an account by accident, then the connection may be assigned an interaction value that is high, regardless of the recent interaction. On the other hand, based on information received from the customer himself, the customer may be assigned an interaction value that is very high due to the customer's displeasure with being treated poorly in view of the customer's long-standing and deep relationship with the entity. Such a high interaction value may be 100 out of 100, for example. In another example, if the connection does not currently use the institution for any products, the connection may be deemed a very low interaction value, particularly if the connection is not considered a target for future business. Such a value may be a 0 out of 100, for example. On the other hand, if the connection does not have any products of the institution, the institution may view the connection as a target, and therefore, may assign a very high interaction value to the connection.

In some embodiments of the invention, the first set of data is analyzed to create a hierarchy of influence wherein the levels of connection between two or more of the connections in the customer's social network are compared. In the embodiment illustrated in FIG. 3, a computing processor 360 collects information from the customer's social network 310, consistent with the process flow illustrated in FIGS. 1 and 2 and described herein. The computing processor 360 identifies the customer's connections 330 and places the connections in a hierarchy of influence based on the connections' 330 relationship with the customer 320. As defined herein, a customer's social network 310 may include a wide variety of individuals and/or organizations ranging from the customer's closest friend to an individual with which the customer 320 has little to no personal interaction, such as a person who works in a different department of the same company as the individual. The customer's best friend may be more likely to be similar to the customer 320 (in circumstance, life position, experience, world-view etc.) than a little known work colleague. Moreover, the best friend's views and behaviors may be more likely to influence the behaviors of the customer 320 then someone not as close to the customer 320. The hierarchy of influence is illustrated by the concentric circles in FIG. 3, with the inner circles representing a higher degree of connection with the customer 320 and consequently, a higher likelihood of being similar to and/or influencing the customer 320 and the outer circles representing a lesser degree of connection with the customer 320.

The levels of connection between two or more of the connections and the customer can be determined in any manner suitable for the purpose. For instance, and without limitation, the levels of connection may be determined through self-identification, i.e. both parties indicate they are siblings, a photograph from a family reunion is uploaded to a social network and the caption identifies both parties as members of the family, the customer identifies a connection as his or her best friend etc. The levels of connection may also be determined through the frequency of traffic between the customer and connection over the social network. For example, if the customer sends direct communications to a connection more frequently than she does other connections within the social network it may be because the customer has a higher level of connection with the individual. Similarly if the customer interacts directly with the posts or information uploaded by the connection to a social network more often than he does with other connections it may be indicative of a higher degree of connection.

In some such embodiments, the computing processor 360 also identifies those connections 330 with an interaction profile. A connection with a conspicuous interaction profile can be either a high interaction value connection 340 wherein the connection's interactions relate to positive average interaction outcomes, or a low interaction value connection 350 wherein the connection's behaviors relate to negative average interaction outcomes. In other embodiments, a high value is assigned to those connections having a negative average interaction outcome and a low value is assigned to those connections having a positive average interaction outcome. A high interaction value connection 340 correlated with a high with a high degree of influence may indicate that the customer 320 has a relatively high risk of attriting. If such a high-risk connection is coupled with serious negative interaction of the customer 320, then the connection may be considered an even higher risk of attriting. Conversely, a low interaction value connection 350 with a high degree of influence may indicate that the customer 320 has a moderate or low risk of attriting if the customer has a negative interaction. A high interaction value connection 340 that is not closely connected to the customer 320 may have a high risk or attriting, but a negative interaction, whether serious or minor, may have little, to no, effect on the connection's likelihood of attrition. For example, if a customer's family members (with whom the customer interacts regularly) all have recent positive interactions with the institution, but the customer has a recent negative interaction with the institution, it may indicate that the family members have a moderate to high risk of attriting regardless of their personal interactions with the institution. Comparatively, if the customer's college roommate, who lives across the country and who rarely communicates or interacts with the customer has positive interactions with the institution, the fact that the customer has a negative interaction with the institution may have no effect on the college roommate, and the college roommate may maintain a low risk of attriting.

Still referencing FIG. 3, in some embodiments of the invention, analysis of the first and second sets of data includes gauging the time interval between incidents in the two sets of customer data and the present. This is illustrated by the process flow 370. The computing processor 360 analyzes incidents identified in the social network data and determines the amount of time that has passed since a given incident has occurred. For instance, if a customer posted on a friend's blog that she had recently was denied for a mortgage, such a posting may be relevant a week later as to whether the customer's connections are more likely to attrite. However, if the post is six years old, it may no longer be relevant to likelihood of customer-connections attriting. Similarly, the computing processor 360 analyzes incidents identified in the second set of customer data to determine the amount of time that has passed, as represented by block 374. In the same way that old social networking data is less relevant to a connection's likelihood of attriting, so too older transactional, account history or biographical data may not be indicative of the customer-connection's likelihood of attriting.

In some embodiments, the computing processor creates a hierarchy of influence, where the levels of connections between two or more of the connections in the customer's social network are compared. The computing processor then assigns a relative connection value to each of the connections based on the comparison of the levels of the connections. The computing processor also assigns a relative interaction value to each of the connections. The relative interaction value may be determined based on an interval of time between interactions and the present or may be determined, as discussed above, using a more complex algorithm. The relative connection value and the relative interaction value are then combined, such as by summing, multiplying or otherwise and the result is a determination of risk of attriting, or conversely, likelihood of retention. In some embodiments, a hierarchy of risk is established and those customer-connections having a risk of attrition higher than a predetermined threshold are flagged for contact or other action. For example, in some embodiments, the institution communicates one or more messages to the customer-connections in an effort to minimize the risk of attrition. In some embodiments, each of the individual relative connection values and relative interaction values corresponding to a single connection are combined such as by summing, multiplying, dividing or otherwise resulting in a weighted connection value corresponding to the individual connection. The weighted connection value is then used to determine the risk of attrition of the connection. In some embodiments, as discussed above, a hierarchy of influence is created where the weighted connection values of the various connections are compared. In this regard, the institution may retain information regarding which of the customer's connections have the highest values, and therefore, may choose to target offers or other communications either through the customer or directly to the connection based on the hierarchy of influence of weighted connection values.

In some embodiments, for each connection, a weighted connection value of the connection is determined. In some embodiments, it may be determined based on a combination of a relative interaction value and relative connection value of the connections of the customer. The relative interaction value of a connection is based on the connection's prior interactions with the institution. The relative connection value is based on the connection's degree of connection with the customer. Thus, the weighted connection value represents the risk of attrition of a connection. When this is combined with negative interaction of the customer (at varying levels of seriousness), a risk of attrition corresponding to a specific negative interaction between the customer and the institution may be determined.

In various embodiments, a customer may be influenced indirectly by interactions or events. For example, a customer may be influenced by movement of transaction data and/or movement or events occurring related to one or more of the customer's friends, acquaintances or connections. As another example, a connection may determine that a competing credit card is preferable for some reason, and therefore, the customer may be at a higher risk of initiating use of the competing product. Another example involves the case where a connection and/or customer conducts a large point redemption associated with a rewards account. In such a case, the likelihood of the connection and/or customer closing the associated account or beginning substantial use of another, competing account is high. Thus, special care may be needed with regard to the connection and/or customer in such a case. Information regarding such events, transactions or otherwise may be used in determination of the likelihood of the customer attriting and/or being retained.

In various embodiments, a future network value and/or future likelihood of attrition and/or retention is determined based on the present network value and/or past network values and/or past and/or current likelihoods of attrition and/or retention. For example, in one embodiment, the trend of the customer's network value is charted over time. Various analyses may be conducted on the trend of customer network values. For example, when the network value spikes or plummets, the timing of the change may be correlated to events occurring in the customer's life, the lives of the customer's connections, or other external influences. In some embodiments, the customer's network value trends may be compared to other customer's network value trends and/or may be analyzed in other ways to determine a predicted network value trend for the future. For example, over the course of a long relationship between the financial institution and the customer, the financial institution may be able to predict a long term future trend regarding the customer's future network value.

In various embodiments, the customer's network value and/or likelihood of attrition and/or retention may be determined based on one or more specific product types and/or product classes of interest. For example, a customer may have a network value corresponding to electronics and a different network value corresponding to financial services. In various embodiments, the customer's network value may be determined at least in part on credit bureau data retrieved by the merchant and/or already available to the merchant.

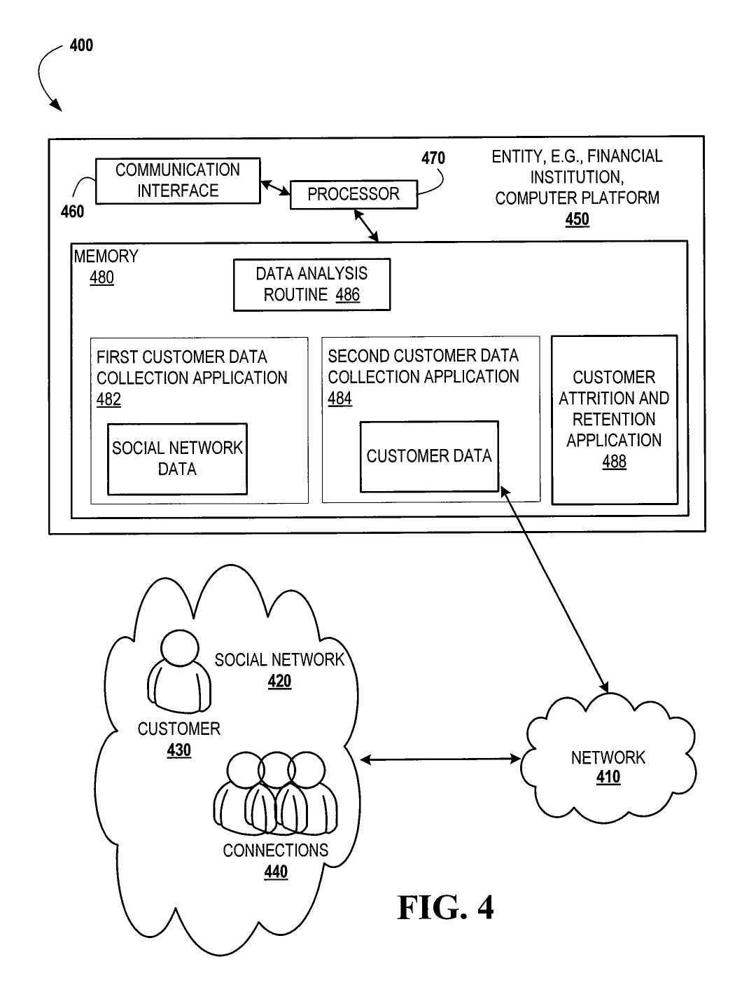

It will be understood that the method for determining a customer's and/or customer-connections' risk of attriting, as illustrated by the process flows 100 and 200 of FIGS. 1 and 2 and the mixed block and flow diagram of FIG. 3, can be embodied in a number of different apparatuses and systems. FIG. 4. provides a block diagram illustrating the technical components of such a system 400, in accordance with an embodiment of the present invention. As illustrated, the system 400 includes a network 410, a social network 420 and an entity computer platform 450.

The entity computer platform 450 may include any computerized apparatus that can be configured to perform any one or more of the functions of the invention described herein. In accordance with some embodiments, for example, the entity computer platform 450 may include an engine, a platform, a server, a database system, a front end system, a back end system, a personal computer system, and/or the like. In some embodiments, such as the one illustrated in FIG. 4, the entity computer platform 450 includes a communication interface 460 a processor 470 and a memory 480. The communication interface 460 is operatively and selectively connected to the processor 470, which is operatively and selectively connected to the memory 480.

The communication interface 460, generally includes hardware, and, in some instances, software, that enables the entity computer platform 450 to transport, send, receive, and/or otherwise communicate information to or from other communication interfaces. For example, the communication interface 460, may include a modem, server, electrical connection and/or other electronic devices that operatively connect the entity computer platform 450 to another electronic device.

The processor 470 generally includes circuitry or executable code for implementing the audio, visual, and/or logic functions of the entity computer platform 450. For example, the processor may include a digital signal processor device, a microprocessor device, and various analog-to-digital converters, digital-to-analog converters, and other support devices. Control and signal processing functions of the system in which the processor resides may be allocated between these devices according to their respective capabilities. The processor 470 may also include functionality to operate one or more software programs based at least partially on computer-executable program code portions thereof, which may be stored, for example, in a memory device, such as the memory 480 of the entity computer platform 450.

The memory 480, may include any computer-readable medium. For example, memory may include volatile memory, such as volatile random access memory (RAM) having a cache area for the temporary storage of data. Memory 480 may also include non-volatile memory, which may be embedded and/or may be removable. The non-volatile memory may additionally or alternatively include an EEPROM, flash memory, and/or the like. The memory 480 may store any one or more pieces of information and data used by the entity computer platform 450 to implement the functions of the entity computer platform 450.

It will be understood that the entity computer platform 450 can be configured to implement one or more portions of the process flows described and/or contemplated herein. For example, as illustrated in FIG. 4, a first customer data collection application 482 may be stored in the memory 480, executable by the processor 470 and configured to collect a first set of data from social networks in which the customer is a member, wherein the first set of data is indicative of the number and quality of connections within the customer's social network. A second customer data collection application 484 may also be stored in the memory 480, executable by the processor 470 and configured to collect a second set of customer data, wherein the second set of customer data comprises data available to an entity based on the prior interactions between the entity and the customer. The first and second sets of customer data collected by the first customer data collection application 482 and the second customer data collection application 484 may be stored in the memory 480 for analysis by the data analysis routine 486 or the data may be dynamically analyzed by the processor 470 without being stored in the memory 480. A data analysis routine 484 is also provided, stored in the memory 480, executable by the processor 470 and configured to correlate said first set of customer data and second set of customer data to indicators of increased risk. A customer network value application 488 may also be stored in the memory 480, executable by the processor 470 and configured to determine a likelihood of attriting of the customer and/or the customer-connections based on the analysis of the first and second sets of data.

As shown in FIG. 4, the social network 420 and entity computer platform 450 are each operatively and selectively connected to the network 410, which may include one or more separate networks. In addition, the network 410, may include a local area network (LAN), a wide area network (WAN), and/or a global area network (GAN), such as the Internet. It will also be understood that the network 410 may be secure and/or unsecure and may also include wireless and/or wireline technology.

It will be understood that the entity computer platform in performing one or more portions of the process flows described and/or contemplated herein will operatively connect to the network 410 through the communication interface 460 to receive data from the customer 430 or connections 440 within the social network 420. For instance, in collecting social network data that relate to the customer's number and quality of connection (as illustrated in FIG. 2, blocks 110, 210 and 220), the entity computer platform 450 may access the social network 420 over the network 410 to identify the connections 440 in the customer's 430 social network 420 to determine the customer's social network position 210 and/or collect expressed data 220 that relates to the customer (e.g. comments, photos or posts concerning the customer's raise and promotion at work etc.). Similarly, in creating a hierarchy of influence, and identifying connections with a conspicuous interaction profile, the entity computer platform 450 may access the social network 420 by using the communication interface 460 to operatively connect to the network 410 and the social network 420 so that the processor 470 may execute the data analysis routine 486 to identify the levels of connection between the connections 440 and the customer 430 and identify information regarding the relative interaction value of the connection 440.

Various embodiments or features have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for identifying one or more customers likely of attriting, the method comprising:
collecting a first set of customer data from one or more social networks in which the customer is a member, wherein the first set of customer data is indicative of a degree of connection of each of a plurality of connections within the one or more social networks;
collecting a second set of customer data, wherein the second set of customer data comprises data available to an entity based on prior interactions between the entity and the customer;
analyzing, using a processing device, the second set of customer data to identify any negative interactions between the entity and the customer; and
correlating, using a processing device, information regarding the identified negative interactions with the first set of customer data to identify one or more connections as customers of the entity at risk of attriting.

2. The method of claim 1 wherein the first set of customer data comprises a network position of the customer.

3. The method of claim 1 wherein the second set of customer data comprises transactional data collected by the entity based on one or more financial transactions conducted with the customer.

4. The method of claim 1 wherein the second set of customer data comprises account history data.

5. The method of claim 1 wherein the second set of customer data comprises biographical data corresponding to one or more connections of the customer.

6. The method of claim 1 wherein analyzing the first set of customer data comprises:
creating, using the processing device, a hierarchy of influence, wherein the levels of connections between two or more of the connections in the customer's social network are compared; and
assigning, using the processing device, a relative connection value based on the comparison.

7. The method of claim 1 wherein analyzing the second set of customer data comprises:
determining the interval of time between interactions within the second set of customer data and the present; and
assigning, using the processing device, a relative interaction value based on the determined interval.

8. The method of claim 7, wherein analyzing the first set of customer data comprises:
creating, using the processing device, a hierarchy of influence, wherein the levels of connections between two or more of the connections in the customer's social network are compared; and
assigning, using the processing device, a relative connection value based on the comparison.

9. The method of claim 8, wherein correlating information regarding the identified negative interaction with the first set of customer data comprises combining the relative connection value and the relative interaction value.

10. The method of claim 9, wherein combining the relative interaction value and the relative connection value comprises summing the relative interaction value and the relative connection value.

11. The method of claim 9, wherein combining the relative interaction value and the relative connection value comprises multiplying the relative interaction value by the relative connection value.

12. The method of claim 1, further comprising:
collecting a third set of customer data wherein the third set of customer data comprises data available to an entity based on prior interactions between the entity and one or more of the plurality of connections within the one or more social networks.

13. The method of claim 12, further comprising:
assigning, using the processing device, a relative interaction value to each of the plurality of connections based on an analysis of the third set of customer data; and
determining, using the processing device, a weighted connection value comprising combining the relative interaction value and the relative connection value of each of the plurality of connections.

14. The method of claim 13, further comprising:
creating, using the processing device, a hierarchy of attrition risk, wherein the weighted connection values between two or more of the connections in the customer's social networks are compared and those connections deemed more likely to attrite are assigned a relatively high probability of attrition and those connections deemed less likely to attrite are assigned a relatively low probability of attrition.

15. The method of claim 14, further comprising:
initiating communication with one or more of the connections in the customer's social network based on the hierarchy of influence.

16. The method of claim 15, wherein the initiated communication is one or more of an email, text message, automatic offer, or customer service telephone call.

17. A system for identifying one or more customers likely of attriting, the system comprising a processing device configured for:
collecting a first set of customer data from one or more social networks in which the customer is a member, wherein the first set of customer data is indicative of a degree of connection of each of a plurality of connections within the one or more social networks;
collecting a second set of customer data, wherein the second set of customer data comprises data available to an entity based on prior interactions between the entity and the customer;
analyzing the second set of customer data to identify any negative interactions between the entity and the customer; and
correlating information regarding the identified negative interactions with the first set of customer data to identify one or more connections as customers of the entity at risk of attriting.

18. The system of claim 17, wherein the first set of customer data comprises a network position of the customer.

19. The system of claim 17, wherein the second set of customer data comprises transactional data collected by the entity based on one or more financial transactions conducted with the customer.

20. The system of claim 17, wherein the second set of customer data comprises account history data.

21. The system of claim 17, wherein the second set of customer data comprises biographical data corresponding to one or more connections of the customer.

22. The system of claim 17, wherein analyzing the first set of customer data comprises:
creating a hierarchy of influence, wherein the levels of connections between two or more of the connections in the customer's social network are compared; and
assigning a relative connection value based on the comparison.

23. The system of claim 17, wherein analyzing the second set of customer data comprises:
determining the interval of time between interactions within the second set of customer data and the present; and
assigning a relative interaction value based on the determined interval.

24. The system of claim 23, wherein analyzing the first set of customer data comprises:
creating a hierarchy of influence, wherein the levels of connections between two or more of the connections in the customer's social network are compared; and
assigning a relative connection value based on the comparison.

25. The system of claim 24, wherein correlating information regarding the identified negative interaction with the first set of customer data comprises combining the relative connection value and the relative interaction value.

26. The system of claim 25, wherein combining the relative interaction value and the relative connection value comprises summing the relative interaction value and the relative connection value.

27. The system of claim 25, wherein combining the relative interaction value and the relative connection value comprises multiplying the relative interaction value by the relative connection value.

28. The system of claim 17, wherein the processing device is further configured for:
collecting a third set of customer data wherein the third set of customer data comprises data available to an entity based on prior interactions between the entity and one or more of the plurality of connections within the one or more social networks.

29. The system of claim 28, wherein the processing device is further configured for:
assigning a relative interaction value to each of the plurality of connections based on an analysis of the third set of customer data; and
determining a weighted connection value comprising combining the relative interaction value and the relative connection value of each of the plurality of connections.

30. The system of claim 29, wherein the processing device is further configured for:
creating a hierarchy of attrition risk, wherein the weighted connection values between two or more of the connections in the customer's social networks are compared and those connections deemed more likely to attrite are assigned a relatively high probability of attrition and those connections deemed less likely to attrite are assigned a relatively low probability of attrition.

31. The system of claim 30, wherein the processing device is further configured for:
initiating communication with one or more of the connections in the customer's social network based on the hierarchy of influence.

32. The system of claim 31, wherein the initiated communication is one or more of an email, text message, automatic offer, or customer service telephone call.

33. A computer program product comprising a non-transient computer readable memory comprising computer executable computer instructions for identifying one or more customers likely of attriting, the instructions comprising:
instructions for collecting a first set of customer data from one or more social networks in which the customer is a member, wherein the first set of customer data is indicative of a degree of connection of each of a plurality of connections within the one or more social networks;
instructions for collecting a second set of customer data, wherein the second set of customer data comprises data available to an entity based on prior interactions between the entity and the customer;
instructions for analyzing the second set of customer data to identify any negative interactions between the entity and the customer; and
instructions for correlating information regarding the identified negative interactions with the first set of customer data to identify one or more connections as customers of the entity at risk of attriting.

34. The computer program product of claim 33, wherein the first set of customer data comprises a network position of the customer.

35. The computer program product of claim 33, wherein the second set of customer data comprises transactional data collected by the entity based on one or more financial transactions conducted with the customer.

36. The computer program product of claim 33, wherein the second set of customer data comprises account history data.

37. The computer program product of claim 33, wherein the second set of customer data comprises biographical data corresponding to one or more connections of the customer.

38. The computer program product of claim 33, wherein the instructions for analyzing the first set of customer data comprise:
instructions for creating a hierarchy of influence, wherein the levels of connections between two or more of the connections in the customer's social network are compared; and
instructions for assigning a relative connection value based on the comparison.

39. The computer program product of claim 33, wherein the instructions for analyzing the second set of customer data comprise:
instructions for determining the interval of time between interactions within the second set of customer data and the present; and
instructions for assigning a relative interaction value based on the determined interval.

40. The computer program product of claim 39, wherein the instructions for analyzing the first set of customer data comprise:
instructions for creating a hierarchy of influence, wherein the levels of connections between two or more of the connections in the customer's social network are compared; and
instructions for assigning a relative connection value based on the comparison.

41. The computer program product of claim 40, wherein the instructions for correlating information regarding the identified negative interaction with the first set of customer data comprise instructions for combining the relative connection value and the relative interaction value.

42. The computer program product of claim 41, wherein the instructions for combining the relative interaction value and the relative connection value comprise instructions for summing the relative interaction value and the relative connection value.

43. The computer program product of claim 41, wherein the instructions for combining the relative interaction value and the relative connection value comprise instructions for multiplying the relative interaction value by the relative connection value.

44. The computer program product of claim 33, wherein the instructions further comprise:
instructions for collecting a third set of customer data wherein the third set of customer data comprises data available to an entity based on prior interactions between the entity and one or more of the plurality of connections within the one or more social networks.

45. The computer program product of claim 44, wherein the instructions further comprise:
instructions for assigning a relative interaction value to each of the plurality of connections based on an analysis of the third set of customer data; and
instructions for determining a weighted connection value comprising combining the relative interaction value and the relative connection value of each of the plurality of connections.

46. The computer program product of claim 45, wherein the instructions further comprise:
instructions for creating a hierarchy of attrition risk, wherein the weighted connection values between two or more of the connections in the customer's social networks are compared and those connections deemed more likely to attrite are assigned a relatively high probability of attrition and those connections deemed less likely to attrite are assigned a relatively low probability of attrition.

47. The computer program product of claim 46, wherein the instructions further comprise:
instructions for initiating communication with one or more of the connections in the customer's social network based on the hierarchy of influence.

48. The computer program product of claim 47, wherein the initiated communication is one or more of an email, text message, automatic offer, or customer service telephone call.
